(19) United States
(12) Patent Application Publication
(10) Pub. No.: US 2026/0222437 A1
(43) Pub. Date: Jul. 30, 2026

(54) NETWORK APPLICATION EXPLOITATION DURING AUTONOMOUS PENTESTING

(71) Applicant: Horizon 3 AI, Inc., Dover, DE (US)

(72) Inventors: Zachary Daniel Hanley, Apex, NC (US); James Walter Horseman, Wesley Chapel, FL (US); Brad Hong, New York, NY (US)

(21) Appl. No.: 19/037,656

(22) Filed: Jan. 27, 2025

(51) Int. Cl. H04L 9/40; H04L 41/50

(52) U.S. Cl. CPC H04L 63/1433; H04L 41/5032; H04L 63/20

(57) ABSTRACT

An autonomous pentesting agent may execute an autonomous pentest of a network, where executing the autonomous pentest includes gaining unauthorized access to a host device of multiple host devices of the network. The autonomous pentesting agent may obtain, using the unauthorized access to the host device, a first cookie specific to a user of the network, the first cookie stored at a memory space of a target application on the host device. The autonomous pentesting agent may communicate with a server of the target application outside of the network, where communicating with the server includes receiving a second cookie associated with the target application based on providing the first cookie to the server, the second cookie being specific to a digital environment of the target application and associated with the network. The autonomous pentesting agent may obtain, using the first and second cookies, information stored in the digital environment.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support network application exploitation during autonomous pentesting.

A method for target application exploitation during autonomous pentesting by an apparatus is described. The method may include executing an autonomous pentest of a network, wherein executing the autonomous pentest comprises gaining unauthorized access to a host device of a plurality of host devices of the network, obtaining, using the unauthorized access to the host device, a first cookie specific to a user of the network, the first cookie stored at a memory space of a target application on the host device, communicating with a server of the target application outside of the network, wherein communicating with the server includes receiving a second cookie associated with the target application based on providing the first cookie to the server, the second cookie being specific to a digital environment of the target application and associated with the network, and obtaining, based at least in part on the unauthorized access to the host device and using the first cookie and the second cookie, information stored in the digital environment of the target application.

An apparatus for target application exploitation during autonomous pentesting is described. The apparatus may include one or more memories storing processor executable code, and one or more processors coupled with the one or more memories. The one or more processors may individually or collectively be operable to execute the code to cause the apparatus to execute an autonomous pentest of a network, wherein executing the autonomous pentest comprises gaining unauthorized access to a host device of a plurality of host devices of the network, obtain, using the unauthorized access to the host device, a first cookie specific to a user of the network, the first cookie stored at a memory space of a target application on the host device, communicate with a server of the target application outside of the network, wherein communicating with the server includes receiving a second cookie associated with the target application based on providing the first cookie to the server, the second cookie being specific to a digital environment of the target application and associated with the network, and obtain, based at least in part on the unauthorized access to the host device and using the first cookie and the second cookie, information stored in the digital environment of the target application.

Another apparatus for target application exploitation during autonomous pentesting is described. The apparatus may include means for executing an autonomous pentest of a network, wherein executing the autonomous pentest comprises gaining unauthorized access to a host device of a plurality of host devices of the network, means for obtaining, using the unauthorized access to the host device, a first cookie specific to a user of the network, the first cookie stored at a memory space of a target application on the host device, means for communicating with a server of the target application outside of the network, wherein communicating with the server includes receiving a second cookie associated with the target application based on providing the first cookie to the server, the second cookie being specific to a digital environment of the target application and associated with the network, and means for obtaining, based at least in part on the unauthorized access to the host device and using the first cookie and the second cookie, information stored in the digital environment of the target application.

A non-transitory computer-readable medium storing code for target application exploitation during autonomous pentesting is described. The code may include instructions executable by one or more processors to execute an autonomous pentest of a network, wherein executing the autonomous pentest comprises gaining unauthorized access to a host device of a plurality of host devices of the network, obtain, using the unauthorized access to the host device, a first cookie specific to a user of the network, the first cookie stored at a memory space of a target application on the host device, communicate with a server of the target application outside of the network, wherein communicating with the server includes receiving a second cookie associated with the target application based on providing the first cookie to the server, the second cookie being specific to a digital environment of the target application and associated with the network, and obtain, based at least in part on the unauthorized access to the host device and using the first cookie and the second cookie, information stored in the digital environment of the target application.

### BRIEF DESCRIPTION OF THE DRAWINGS

FIG. 1 shows an example of a computing environment that supports network application exploitation during autonomous pentesting in accordance with aspects of the present disclosure.

FIG. 2 shows an example of an autonomous pentest map that supports network application exploitation during autonomous pentesting in accordance with aspects of the present disclosure.

FIGS. 3 and 4 show examples of computing environments that support network application exploitation during autonomous pentesting in accordance with aspects of the present disclosure.

FIG. 5 shows an example of a process flow that supports network application exploitation during autonomous pentesting in accordance with aspects of the present disclosure.

FIG. 6 shows a diagram of a system including a device that supports network application exploitation during autonomous pentesting in accordance with aspects of the present disclosure.

FIG. 7 shows a flowchart illustrating methods that support network application exploitation during autonomous pentesting in accordance with aspects of the present disclosure.

### DETAILED DESCRIPTION

Networks may include various network assets, including applications. In some examples, a network may include an application that supports operations of an organization associated with the network. That is, the application, which may be referred to as an enterprise application, may be used by multiple users of the organization, store organization-specific data, support workflow management, be used for internal and external communications, or the like. In some cases, hosts of the network may include or be installed with the application. Put another way, a network associated with an organization that uses the application may include multiple hosts or host devices that include the enterprise application. The application, or a digital environment (e.g., tenant, domain, etc.) of the application specific to the network, may include data or other information of the network. Accordingly, unauthorized access to hosts that include the application may lead to security breaches, including data theft, unauthorized information dissemination, and compromise of communications.

As described herein, autonomous pentesting may be used to identify and suggest remediation for security vulnerabilities of applications that store sensitive network information. For example, an autonomous pentesting agent may execute an autonomous pentest that includes an attempt to gain unauthorized access to the digital environment of the application (e.g., an enterprise application or a target application). Gaining the unauthorized access to the digital environment may include first gaining unauthorized access to a host having the application. For example, the autonomous pentesting agent may obtain access to a host (e.g., directly or indirectly, such as via a remote access trojan (RAT)) and identify and scan a memory space on the host that is associated with the application. The autonomous pentesting agent may scan the memory space of the application on the host for a user-specific cookie. After obtaining the user-specific cookie, the autonomous pentesting agent may communicate with a server of the application to obtain information associated with the network, including the digital environment of the application and an environment-specific cookie. The autonomous pentesting agent may use the user-specific cookie and the environment-specific cookie to gain unauthorized access to the digital environment and obtain information associated with the network. Based on the unauthorized access and the information obtained during the autonomous pentest, the autonomous pentesting agent may report what information was obtained and recommend remediation to address security vulnerabilities that led to unauthorized access. By enabling identification of these security vulnerabilities and recommendations for remediation, techniques described herein support improved network security at hosts having applications that store sensitive network information.

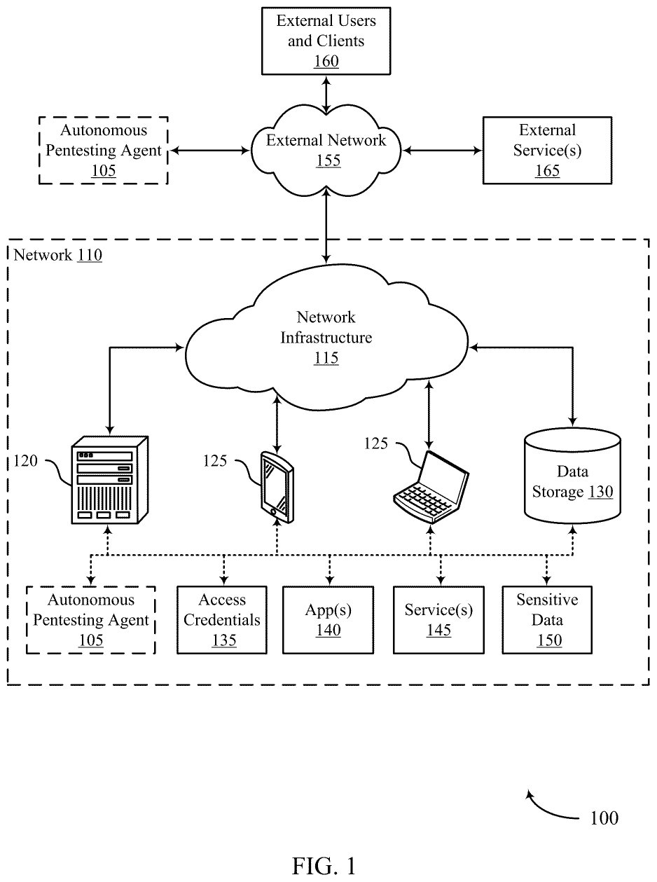

FIG. 1 illustrates an example of a computing environment 100 that supports network application exploitation during autonomous pentesting in accordance with aspects of the present disclosure. The computing environment 100 may include an autonomous pentesting agent 105 that performs an autonomous pentest of a network 110. The network 110 may include one or more devices or systems, such as a network infrastructure 115, server 120, computing devices 125, data storage 130, or any combination thereof. The devices or systems of the network 110 may be configured to access or provide various network information and services, such as access credentials 135, app(s) 140, service(s) 145, sensitive data 150, or any combination thereof.

The network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the network 110 as well as communication between the network 110 (e.g., the private network) and an external network 155 (e.g., the Internet). The network 110 may include aspects of one or more wired networks, one or more wireless networks (e.g., cellular networks), or any combination thereof. The network 110 may include aspects of one or more public networks or private networks, as well as secured or unsecured networks, or any combination thereof. For example, the network 110 may be an example of a private network that includes one or more public-facing or external assets that are accessible via an external network 155. As an example, the external network 155 may refer to the Internet, and users, such as external users and clients 160, may access the network 110 via the external network 155 through a website or application that is on the external network 155. For example, the external users and clients 160, the external service(s) 165, or both may access network information and services via the external network 155 (e.g., via the Internet), including the access credentials 135, app(s) 140, service(s) 145, and sensitive data 150.

The network 110 may be accessible via one or more hosts. For example, hosts may be examples of real or virtual machines that are connected to and capable of accessing the network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the network 110 and outside of the network (e.g., with devices in an external network 155). For example, the server 120 may send data to and receive data from one or more of the computing devices 125. Additionally, or alternatively, hosts may access resources of the network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to machines that include network shares. For example, network assets may be examples of machines (e.g., real or virtual machines) that include shares of the network 110, such as file sharing systems. Network assets may be obtained and utilized by attackers to compromise the network 110. The server 120, the computing devices 125, the data storage 130, and the access credentials 135, app(s) 140, service(s) 145, and sensitive data 150 accessible via the devices and systems of the network 110 may all be examples of network assets. For example, physical devices (e.g., servers, computing devices, data storage, etc.) and systems may be considered network assets as well as information, apps, and services accessible through physical devices and systems of the network 110.

Hosts may store, provide, or implement access credentials 135, app(s) 140, service(s) 145, sensitive data 150, or any combination thereof. In some cases, computing devices 125 on the network may access the one or more assets (e.g., access credentials 135, app(s) 140, service(s) 145, sensitive data 150, etc.) via the server 120 (e.g., via a host). Additionally, or alternatively, computing devices 125 may locally store or otherwise access the one or more assets of the network 110. For example, users of the network 110 may access app(s) 140 and service(s) 145 via the computing devices 125 directly or indirectly (e.g., via a connection between the computing devices 125 and the server 120).

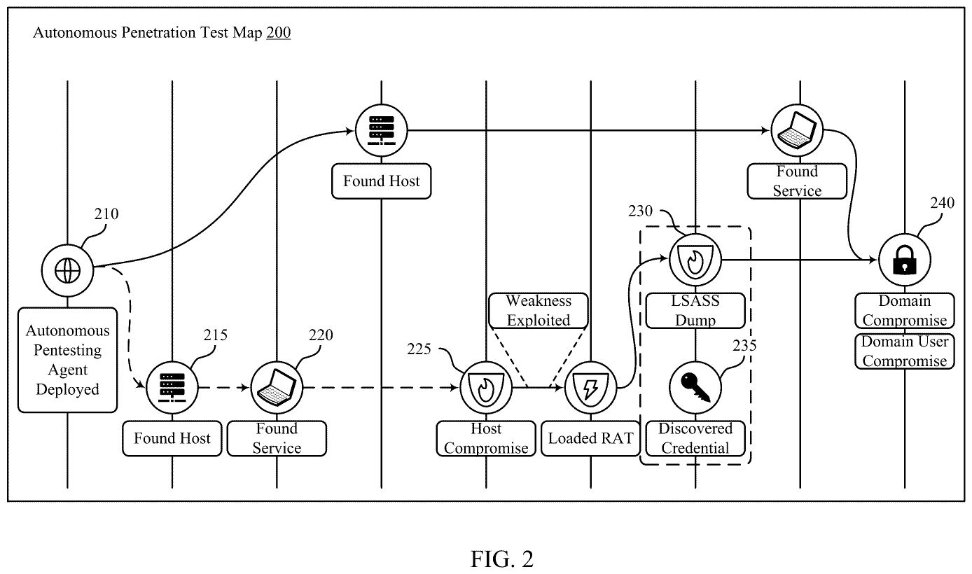

The autonomous pentesting agent 105 may perform a pentest of the network 110. As used herein, a penetration test or a “pentest” may refer to one or more security operations that simulate a cybersecurity attack in order to identify vulnerabilities in the network 110. The autonomous pentesting agent 105 may perform the pentest of the network 110 using one or more artificial intelligence (AI) models. For example, the autonomous pentesting agent 105 may be “autonomous,” as the autonomous pentesting agent 105 may perform the pentest without a requirement of hard-coding, user inputs, or the like and, instead, by using the one or more AI models. The autonomous pentesting agent 105 may identify, via the pentest, security vulnerabilities of the network 110. An example of an output of the pentest may be described in greater detail elsewhere herein, including with reference to FIG. 2.

The autonomous pentesting agent 105 may, via the one or more AI models, determine and implement an attack path for a pentest. For example, the autonomous pentesting agent 105 may identify or select an asset of the network 110 to attempt to access initially and, from that asset, another asset to attempt to access, and so on. In other words, the autonomous pentesting agent 105 may use the one or more AI models to mimic decisions of an attacker. The one or more AI models may output a targeted asset of the network 110 to be subject to an access attempt by the autonomous pentesting agent 105 based on inputs including context of various assets in the network 110. In other words, the one or more AI models may output targeted assets based on the relative position of assets within the network 110, asset types, downstream assets (e.g., accessible after or through accessing a targeted asset), or the like.

The one or more AI models may be trained using data of previous pentests of the network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the network 110 previously or on other networks, or both. The autonomous pentesting agent 105 may perform improved pentests after the one or more AI models are trained using previous pentests of the network 110. That is, as the autonomous pentesting agent 105 learns more about the network 110, the autonomous pentesting agent 105 may perform pentests with higher performance levels (e.g., higher accuracy, higher quantities of potential attack paths, etc.).

In some cases, the pentest may be internal or external to the network 110. For example, the autonomous pentesting agent 105 may be deployed at a host device of the network 110 (e.g., deployed to the server 120 or computing devices 125). In such examples, the autonomous pentesting agent 105 may perform the pentest as an internal user of the network 110. Such internal pentests may be indicative of or emulate internal security threats to the network, such as from employees of an organization or an attacker that has otherwise obtained access to the network 110 internally. Alternatively, the autonomous pentesting agent 105 may be deployed at the external network 155. For example, the autonomous pentesting agent 105 may perform the pentest as an external user of the network 110, such as by accessing external or public-facing assets of the network 110 on the external network 155.

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the network 110 against cybersecurity attacks relative to hard-coded (e.g., automated) or manual (e.g., human operated) pentests.

Techniques described herein may support improved network security. For example, by performing autonomous pentests that attempt to gain unauthorized access to digital environments of applications that are associated with a network, techniques described herein may be implemented to identify security vulnerabilities and implement improved network security policies at applications of a network 110. The autonomous pentesting agent 105 may inspect the contents (e.g., messages, files, users, etc.) of applications (e.g., collaboration applications) in a manner that bypasses intended authentication workflows. For example, an autonomous pentesting agent 105 may, during an autonomous pentest, attempt to gain unauthorized access to (e.g., programmatically access) a digital environment through one or more hosts and using application information stored on the one or more hosts. The autonomous pentest may enable identification of hosts that are vulnerable to unauthorized access leading to compromise of application data, improved data storage policies that prevent persistent storage of sensitive information, or the like. That is, the autonomous pentest targeting the application may enable identification of security vulnerabilities (e.g., issues) and reporting of corresponding remediations that address the identified security vulnerabilities. Such security vulnerabilities may not be identifiable or accessible using traditional techniques, as the data sources may be blocked by authentication workflows.

Additionally, techniques described herein may support improved understanding of security vulnerability impact. For example, some security systems, including breach and attack simulation (BAS) tools, vulnerability scanners, or the like, may identify security vulnerabilities by fingerprinting network assets. The security systems may compare the fingerprinting of assets to a list of known bad actors to determine which assets are vulnerable. However, without performing attacks (e.g., pentests), security systems may fail to identify which of the assets have vulnerabilities that could lead to compromise events based on fingerprinting and comparison to bad actors alone. That is, security systems may fail to identify an impact associated with a given security vulnerability.

However, by identifying security vulnerabilities via an autonomous pentest, the autonomous pentesting agent 105 may evaluate impact associated with security vulnerabilities by testing the vulnerabilities in the context of the network infrastructure and technology stack that the vulnerabilities exist in. Put another way, the autonomous pentesting agent 105 may prioritize security vulnerabilities as being more “important” (i.e., having potential for more severe compromise events) than other security vulnerabilities by testing how the security vulnerabilities can be exploited during autonomous pentesting. An example of such an evaluation based on exploitation of vulnerabilities during pentesting—rather than fingerprinting—may be described in greater detail elsewhere herein, including with reference to FIG. 2.

FIG. 2 shows an example of an autonomous pentest map 200 that supports network application exploitation during autonomous pentesting in accordance with aspects of the present disclosure. The autonomous pentest map 200 may be an example of an output or result of an autonomous pentest performed by an autonomous pentesting agent, such as a pentest performed by the autonomous pentesting agent 105 in the network 110 as described with reference to FIG. 1. The autonomous pentest map 200 may illustrate and describe an example of events of a pentest, including operations performed by and information obtained by the autonomous pentesting agent.

The autonomous pentest map 200 may include one or more types of events. For example, the autonomous pentest map 200 may include deployment 210 (e.g., of the autonomous pentesting agent), host identification 215, service identification 220, host compromise 225, deployment of an attacker tool 230 (e.g., a RAT, credential identification 235, and access 240 (e.g., to a domain, a domain user, or both). The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent pay perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support exploitation of applications on a network. For example, an attack branch described herein may involve an attack branch similar to the second attack branch. That is, the autonomous pentesting service may find a host and, through the identified host, a service (e.g., or an application). The autonomous pentesting service may load a RAT on the found host, scan a memory space, discover a credential (e.g., a cookie or token), and use that credential to obtain information via the service and achieve domain compromise. By achieving this compromise through autonomous pentesting, the techniques described herein may support improved network security via identification of security vulnerabilities. As an example, the autonomous pentesting service may identify the host as a security vulnerability and suggest that security mitigations may be applied accordingly.

The autonomous pentesting service may further evaluate an impact associated with one or more of the identified security vulnerabilities by testing the vulnerabilities in the context of the network infrastructure and technology stack that are specific to a network. Put another way, the autonomous pentesting agent may prioritize one or more identified security vulnerabilities as being more “important” (i.e., having potential for more severe compromise events) than other security vulnerabilities by testing how the security vulnerabilities can be exploited within the specific context of the network during autonomous pentesting.

For example, In an attack branch involving found credentials on a host, the autonomous pentesting service may chain together (e.g., in the attack branch) different exploitations, misconfigurations, and captured loot (e.g., assets, data, etc.) by logging into an application via a digital environment specific to a network. The autonomous pentesting service may use the login to obtain a domain administrator privilege. The autonomous pentesting service may run a command (e.g., an “ls” Linux command) to display contents of a directory and permissions of each user in the directory. The output of the command may prove (e.g., beyond theorizing a security impact, such as via fingerprinting) that sensitive information is accessible through an attack of the network. In another example, the autonomous pentesting service may perform a directory file command “dir” to list all files and directories from each user perspective. The output of the command may similarly prove (e.g., beyond theorizing a security impact) that the files and directories are accessible through an attack of the network. Based on the contents of the files and directories, the autonomous pentesting service may also indicate an impact type (e.g., a ransomware exposure impact type) associated with the vulnerability.

The autonomous pentesting service may output an indication of the proven unauthorized access or discovered vulnerabilities to an administrator or other responsible party associated with the network. This output may be in the form of an electronic notification (e.g., an application notification, an email, or a text message) to the responsible party, to a user of the autonomous pentesting service, or both. The output may include an indication of the identified impact type or severity associated with the unauthorized access or discovered vulnerabilities. The autonomous pentesting service may include one or more suggested actions to take to address and remediate the unauthorized access or discovered vulnerabilities. Different impact types or severities of vulnerabilities may be associated with different types of suggested actions. In some cases, the autonomous pentesting service may autonomously remediate the discovered vulnerabilities or unauthorized access by agentically performing one or more of the identified actions. Autonomous remediation actions by the autonomous pentesting service may be reserved for more severe vulnerabilities. For example, the autonomous pentesting service may perform immediate (e.g., after completion of the autonomous pentest and/or without user input) steps to remediate severe vulnerabilities but simply report and defer to the administrator of the network (e.g., wait to receive user input) on remediation actions for less severe vulnerabilities.

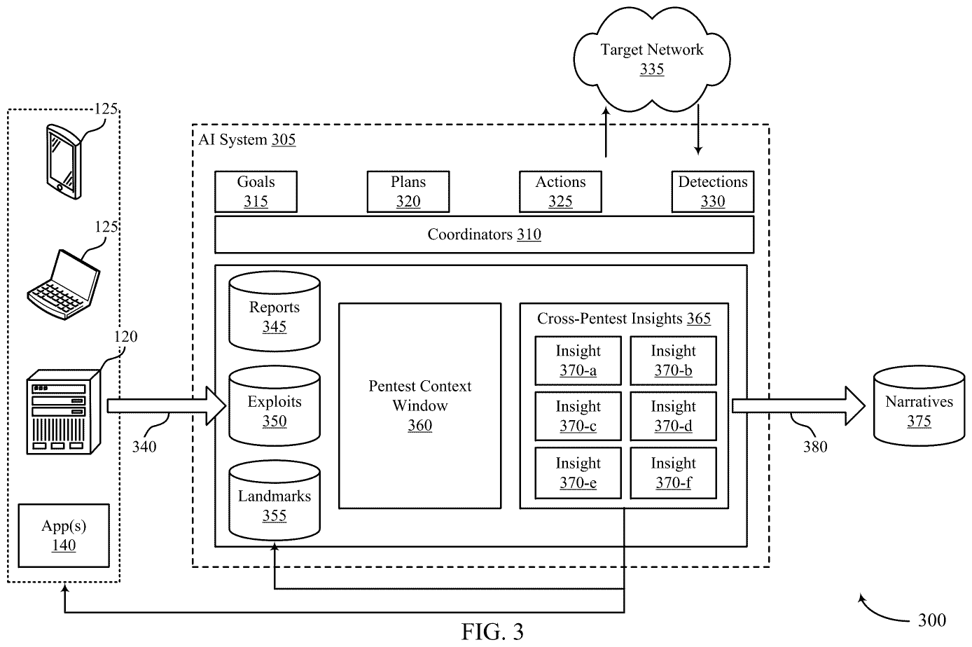

FIG. 3 shows an example of a computing environment 300 that supports network application exploitation during autonomous pentesting in accordance with aspects of the present disclosure. The computing environment 300 may implement or be implemented by the computing environment 100, the autonomous pentest map 200, or both. For example, the computing environment 300 may illustrate servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions. In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously, at least for some operations, to achieve specified goals, make decisions, and take actions without direct human intervention (e.g., through the use of AI agents). In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may interface with one or more coordinators 310 that coordinate goals 315 and plans 320, actions 325, and detections 330 for achieving the goals 315. For example, for autonomous pentesting, the goals 315 of the AI system 305 may be to obtain access to data stored within a network 110, compromise (such as by obtain unauthorized administrative access or deploying unauthorized software to) a domain or a network asset of the network 110, or any combination thereof. To obtain the goals 315, the AI system 305 may generate one or more plans 320 that are based on actions 325 and detections 330. For example, to determine a next best action within a defined set of guardrails or instructions, the AI system 305 may generate a plan 320 that can include an action 325 to invoke (e.g., execute) one or more commands on a target network 335 to obtain a detection 330 from the target network 335.

In some examples, the target network may include one or more network assets such as servers 120, computing devices 125, data storages 130, app(s) 140, or any combination thereof. Further, obtaining a detection 330 from the target network 335 may include the AI system 305 retrieving telemetry data from the one or more network assets of the target network 335. In some cases, telemetry data obtained from the target network 335 may include logs, traces, metrics, events, or any combination thereof from the one or more network assets of the target network 335. For example, a detection 330 may include some data that is obtained from the target network 335 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 335, which may be utilized for achieving a respective goal 315. For example, a goal 315 may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, or billions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 thar resulted in the action 325 succeeding or failing, or any combination thereof. Therefore, the AI system 305 may continuously obtain and update the training data used for training AI/ML models and perform reinforcement learning using collective intelligent to improve the weights and training of the AI/ML models.

In some examples, the training data for the AI system 305 may include telemetry data obtained from the target network 335, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 335) to assist the AI system 305 to navigate and map a target environment during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by proving the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 335, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may processes information about ongoing pentests, including successfully exploited vulnerabilities, accessed systems and data, attempted but failed exploit paths, among others.

In some examples, the AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of cross-pentest insights 365 that indicates one or more insights 370 (e.g., an insight 370-a, an insight 370-b, an insight 370-c, an insight 370-d, an insight 370-e, and an insight 370-f). For example, the insight 370-a may indicate patterns of vulnerable default configurations in commonly used enterprise software. In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant network compromise. Therefore, the cross-pentest insights 365 may indicate one or more insights 370 that represent patterns and vulnerabilities that occur across different networks and testing scenarios, helping organizations better understand systemic security weaknesses that need to be addressed. For example, the cross-pentest insights 365 may be added as landmarks 355 for further training the AI system 305 to perform autonomous pentests.

In some examples, the cross-pentest insights 365 may be displayed to one or more computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate one or more narratives 375 that indicate the insights 370 obtained in response to one or more autonomous pentests. In some examples, to generate the one or more narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more insights 370 about the security compliance of a network 110. In another example, a narrative 375 may be a presentation for a company or organization that indicates the one or more vulnerabilities in a network 110 associated with the company or organization. For example, the presentation can indicate the cross-pentest insights 365 obtained from performing one or more autonomous pentests on the network 110 associated with the company or organization (e.g., the target network 335).

An autonomous pentesting service may utilize the AI system 305 to exploit an application on the target network 335. For example, the autonomous pentesting service may utilize the AI system 305 to obtain cookies usable to access network information in a target application of the network. The autonomous pentesting service may use the AI system 305 to scan memory spaces, responses from an external server, or both for sensitive or valuable information, including credentials (e.g., cookies or tokens), PII, or the like.

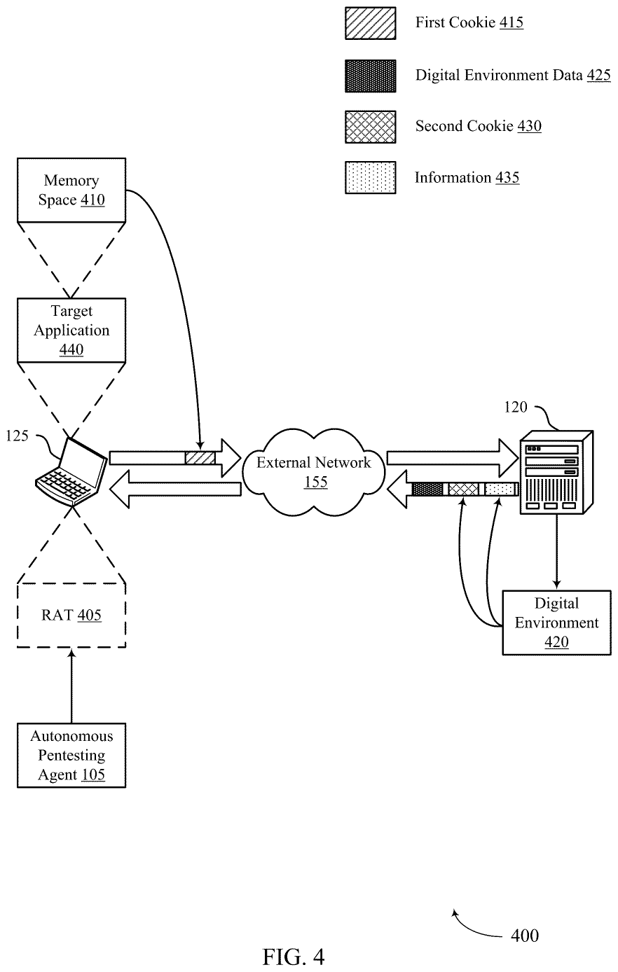

FIG. 4 shows an example of a computing environment 400 that supports network application exploitation during autonomous pentesting in accordance with aspects of the present disclosure. The computing environment 400 may implement or be implemented by the computing environment 100, the autonomous pentest map 200, the computing environment 300, or any combination thereof. For example, the computing environment 400 may include a computing device 125 of a network, such as the network 110 as described with reference to FIG. 1. The computing device 125 may be referred to as a host device. The computing device 125 may communicate, via the external network 155, with a server 120 of a target application 440, which may be an example of one of the app(s) 140 as described with reference to FIG. 1. The autonomous pentesting agent 105 may perform an autonomous pentest of the network that includes the computing device 125.

For example, the autonomous pentesting agent 105 may gain unauthorized access to the computing device 125. In one example, the autonomous pentesting agent 105 may gain unauthorized access to the computing device 125 by deploying a RAT 405 on the computing device 125. The autonomous pentesting agent 105 may deploy the RAT 405 via a phishing email, malicious downloads, exploiting software vulnerabilities, or the like. In another example, the autonomous pentesting agent 105 may directly access the computing device 125, such as according to a configuration of the autonomous pentest. For example, the autonomous pentesting agent 105 may be deployed to the computing device 125 for the autonomous pentest. The autonomous pentesting agent 105 may perform the operations described herein as a part of the autonomous pentest and using the unauthorized access to the computing device 125. Put another way, the unauthorized access, via the RAT 405 or otherwise, to the computing device 125 may serve as the primary tool for the subsequent actions by the autonomous pentesting agent 105.

The autonomous pentesting agent 105 may perform a scan of the computing device 125 (e.g., an operating system (OS) of the computing device 125) to determine whether a target application 440 is running. For example, the autonomous pentesting agent 105 may attempt to gain unauthorized access to one or more target applications during the autonomous pentest. In some examples, the one or more target applications may be indicated as a target for the autonomous pentest via one or more user inputs. That is, a user may indicate that security vulnerabilities of a target application 440 are to be tested by the autonomous pentesting agent 105 during the autonomous pentest and, based on this indication, the autonomous pentesting agent 105 may scan the computing device 125 to determine whether the target application 440 is running.

In a first example, the autonomous pentesting agent 105 may determine whether the target application 440 is running on the computing device 125 by scanning for processes with names associated with the target application 440. For example, for an application named “collaboration,” the autonomous pentesting agent 105 may scan for processes named “collaboration. exe” or for other names that are associated with the application. In a second example, the autonomous pentesting agent 105 may determine whether the target application 440 is running on the computing device 125 by accessing an OS manifest of all installed programs on the computing device 125 or user-specific metadata associated with the target application 440. That is, the autonomous pentesting agent 105 may identify the target application 440 in the OS manifest of the installed programs, or identify data in a format or of a type that is indicative of the target application 440.

The autonomous pentesting agent 105 may perform a scan of a memory space 410 associated with the target application 440. For example, the autonomous pentesting agent 105 may open handles to processes of the target application 440 and perform a scan of the memory space 410 (e.g., or multiple memory spaces) of the target application 440. As used herein, a handle may refer to an abstract reference to the process, such as a unique identifier or token, that the autonomous pentesting agent 105 may use to interact with the process associated with the target application 440.

The autonomous pentesting agent 105 may use application programming interfaces (APIs) of an OS of the computing device 125 to interact with processes having process identifiers associated with the target application 440. For example, the autonomous pentesting agent 105 may use the APIs of the OS to interact with the processes identified during the scan for processes associated with the target application 440. The autonomous pentesting agent 105 may interact with the processes by opening a handle to a process (e.g., which may indicate that the autonomous pentesting agent 105 would like to interact with that process) and then by querying an OS API for information.

For example, in a Windows environment, the autonomous pentesting agent 105 may open a process handle using an OpenProcess() function of the Windows API. The autonomous pentesting agent 105 may use the OpenProcess() function to specify the process identifier of the process associated with the target application 440 and to request full access to the memory space associated with that process.

For example, the autonomous pentesting agent 105 may query the OS API for information including random access memory (RAM) usage, open file handles, and memory space addresses associated with the process. That is, the autonomous pentesting agent 105 may query the OS API to identify memory space addresses corresponding to memory spaces of the target application 440, including the memory space 410.

Based on identifying the memory space addresses, the autonomous pentesting agent 105 may identify the memory spaces of the target application 440, query the memory spaces, and read content of the memory spaces. For example, the autonomous pentesting agent 105 may identify the memory space 410 corresponding to a memory space address and query the memory space 410. By querying the memory space 410, the autonomous pentesting agent 105 may read content of the memory space 410. As used herein, reading the memory space 410 may be referred to as “scanning” the memory space 410.

For example, the autonomous pentesting agent 105 may scan the memory space 410 for cookies. Put another way, the autonomous pentesting agent 105 may scan the memory space 410 to identify and extract instances of cookies associated with the target application 440. The cookies may be used for maintaining user sessions and authentication states. That is, a first cookie 415 extracted from the memory space 410 may be user-specific. User-specific cookies may be generic across digital environments, and in some examples, may start with “XOXD-.”

The autonomous pentesting agent 105 may scan the memory space 410 for the cookies based on a format of cookies associated with the target application 440. For example, applications on computing devices may communicate with one or more servers 120 in a human-readable manner. The cookies may be in a standardized format for the target application 440, which, once known by the autonomous pentesting agent 105, may be used to search for matching cookies in the memory space 410. In some examples, the autonomous pentesting agent 105 may scan the memory space 410 using a model, such as an LLM. For example, the autonomous pentesting agent 105 may use the model to extract potential cookies based on known regular expressions or textual patterns. Additionally, or alternatively, the autonomous pentesting agent 105 may use other indicators, such as proximity of the potential cookie to a uniform resource locator (URL) associated with an authentication endpoint (e.g., URLs that include “collaboration. com” in the example of a target application 440 named “Collaboration”) in memory, to further help identify cookies.

The autonomous pentesting agent 105 may transmit a request to the server 120 associated with the application that includes the first cookie 415. For example, the autonomous pentesting agent 105 may use the first cookie 415 (e.g., identified by scanning the memory space 410) to make a request (e.g., a generic “GET” request) to the server 120. Transmitting the request to the server 120 may refer to making a request to a website of the application (e.g., collaboration. com). Based on the request including the first cookie 415, the server 120 may respond with digital environment data 425 about a digital environment 420 associated with the first cookie 415. For example, the server 120 may transmit, in response to the request including the first cookie 415, a response including digital environment data 425 associated with the digital environment 420.

As used herein, a digital environment may refer to a tenant, domain, or workspace that is specific to a network and on a target application 440. That is, the target application 440 may be used by multiple different networks and have separate digital environments for each of the different networks. For example, the digital environment 420 may be specific to the network (e.g., of the computing device 125) and the digital environment 420 may be a part of the target application 440. The user of the computing device 125 may have access to the digital environment 420 of the target application 440, which may include or store information associated with the network. As examples, the digital environment 420 may be a Slack workspace (e.g., when the target application 440 is Slack) or a Team (e.g., when the target application 440 is Microsoft Teams).

The autonomous pentesting agent 105 may scan the digital environment data 425 to extract URLs associated with workspaces to which a user of the computing device 125 has access (e.g., workspace. collaboration. com). For example, the autonomous pentesting agent 105 may scan the digital environment data 425 received in the response to identify the digital environment 420 that is specific to the network of the computing device 125. Based on extracting the digital environment 420 from the digital environment data 425, the autonomous pentesting agent 105 may transmit an additional request including the first cookie 415. For example, the autonomous pentesting agent 105 may transmit requests including the first cookie 415 to each of the extracted URLs. The requests may be examples of a “who am I” request to retrieve a user profile, username, email address, workspace information, or any combination thereof.

In response to the request, the server 120 may transmit a response that includes a second cookie 430. The second cookie 430 may be an example of a workspace-specific cookie. That is, the second cookie 430 may be specific to the digital environment 420. The second cookie 430 may be an example of an API token and, in some examples, may grant access to one or more functionalities within the digital environment 420, be used for transmitting authenticated API requests, or both.

The autonomous pentesting agent 105 may scan the response for the second cookie 430. Scanning the response for the second cookie 430 may include searching for expressions in the response. In one example, workspace-specific API tokens may start with “XOXC-” and may be found in the response to the request made to the extracted URLs. The cookies found in the response to the request may be used to access the digital environment 420 (e.g., retrieve data including messages, files, etc.).

Using the first cookie 415 and the second cookie 430, the autonomous pentesting agent 105 may obtain unauthorized access to the digital environment 420. For example, the autonomous pentesting agent 105 may transmit authenticated requests (e.g., API requests) as the user of the computing device 125 within the digital environment 420. That is, the first cookie 415 may allow the autonomous pentesting agent 105 to impersonate the user, and the second cookie 430 may allow the autonomous pentesting agent 105 to access the digital environment 420 as the user. The autonomous pentesting agent 105 may obtain information 435 from the server 120, including messages, files, channels, and potentially sensitive information.

In some examples, the autonomous pentesting agent 105 may use a pilfering code to extract information from the information 435 obtained from the server 120. For example, the information 435 may include messages, files, channels, or other data associated with the digital environment 420. Based on file names, file types (e.g., text, configuration, batch script, etc.), the pilfering code may determine whether to retrieve files and scan the files for sensitive information including PII, credentials (e.g., tokens, such as Amazon Web Services (AWS) tokens or Microsoft Azure tokens, username and password combinations, or the like), trade secrets, or other sensitive information. The autonomous pentesting agent 105 may use the extracted information to provide feedback, such as via a network assessment report.

The autonomous pentesting agent 105 may output the network assessment report based on the autonomous pentest. For example, the autonomous pentesting agent 105 may output a network assessment report based on gaining unauthorized access to the computing device 125 and the digital environment 420. The network assessment report may include recommendations for remediating the discovered security vulnerabilities. For example, the network assessment report may recommend a policy-based mitigation, such as advising users of the network to not upload sensitive information to the target application 440. Additionally, the network assessment report may recommend shortening message and file retention periods to mitigate damage if users were to not follow the policy. In another example, the network assessment report may recommend a security mitigation that addresses initial access to the computing device 125 (e.g., network compromise that led to the RAT 405 being deployed).

In some examples, the autonomous pentesting agent 105 may perform security mitigations based on the autonomous pentest. For example, the autonomous pentesting agent 105—in addition to or alternatively from outputting the network assessment report—may delete sensitive data found during the autonomous pentest, including data, files, messages, or the like accessible via obtaining the unauthorized access to the digital environment 420. By deleting the sensitive data, the autonomous pentesting agent 105 may prevent such data from being compromised.

The autonomous pentesting agent 105 may perform the autonomous pentest periodically (e.g., daily, weekly, monthly, etc.). For example, the autonomous pentesting agent 105 may periodically execute the autonomous pentest to identify sensitive information in the digital environment 420. The autonomous pentesting agent 105 may output a network assessment report indicating the sensitive information such that the organization may perform manual remediation, or the autonomous pentesting agent 105 may autonomously perform remediation and provide a report (e.g., by generating and outputting an email, notification, report graphic, or other indication) of sensitive information discovered, other vulnerabilities identified after bypassing authentication protocols, and/or remediation actions taken to address the sensitive information or vulnerabilities. For example, remediation may include deleting, encrypting, or quarantining sensitive information, disabling.

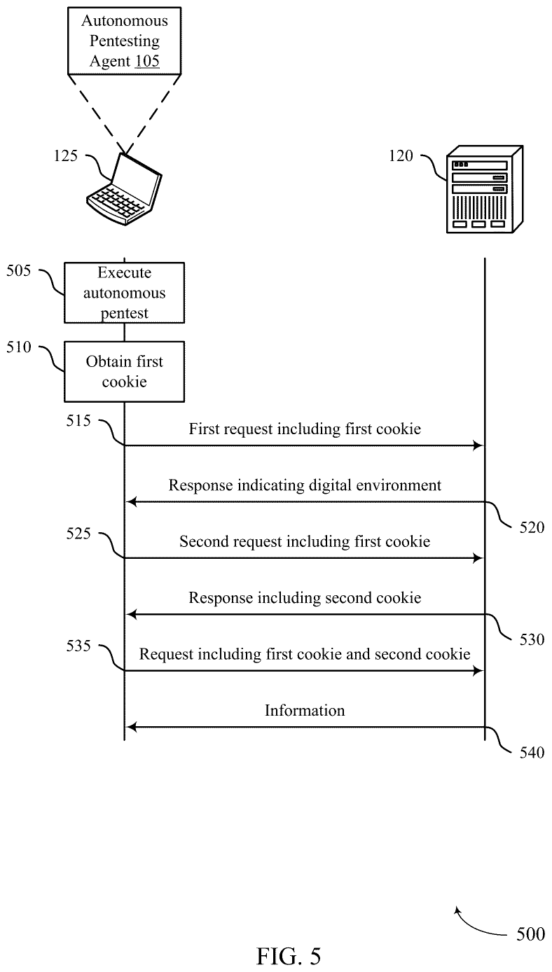

As an illustrative example, the processes of FIG. 5 are discussed below for a case in which the target application 440 is a cloud-based team communication platform, such as Slack. In such an example, the autonomous pentesting agent 105 may scan the processes of the computing device 125 to determine whether Slack is running, including scanning for processes such as “Slack.exe.” Additionally, or alternatively, the autonomous pentesting agent 105 may identify Slack in the OS manifest of installed programs or based on user-specific metadata associated with Slack. The autonomous pentesting agent 105 may open handles to the Slack processes and perform a memory scan of memory spaces associated with Slack. For example, the autonomous pentesting agent 105 may scan memory spaces associated with Slack processes to identify and extract instances of known Slack application cookies (e.g., including the first cookie 415) using regular expressions. In some examples, the autonomous pentesting agent 105 may identify the cookies based on proximity of potential cookies to a URL associated with an authentication endpoint of the target application 440, such as URLs that include “slack.com.”

After obtaining the first cookie 415 via the memory scan, the autonomous pentesting agent 105 may use the first cookie 415 to make a request (e.g., a “GET” request) to the Slack website (e.g., slack.com). In response, the Slack server (e.g., the server 120) may transmit data about the proper workspace URL(s), such as workspace. slack. com, associated with the first cookie 415. That is, the Slack server may direct the user to a specific workspace (e.g., digital environment 420) where the first cookie 415 is usable. In some examples, the Slack server may indicate multiple workspace URLs associated with the first cookie 415, such as multiple workspaces that the user associated with the first cookie 415 is a part of.

The autonomous pentesting agent 105 may transmit additional requests including the first cookie 415 to the workspace URL(s) and scan the response(s) for workspace-specific cookies (e.g., including the second cookie 430) that grant access to functionalities within the Slack workspace(s) and are used to make authenticated API requests. Using the first cookie 415 and the second cookie 430, the autonomous pentesting agent 105 may make requests as the user (e.g., associated with the first cookie 415) in the Slack workspace, including accessing messages, files, channels, and potentially sensitive information.

FIG. 5 shows an example of a process flow 500 that supports network application exploitation during autonomous pentesting in accordance with aspects of the present disclosure. The process flow 500 may implement or be implemented by the computing environment 100, the autonomous pentest map 200, the computing environment 300, the computing environment 400, or any combination thereof. For example, the process flow 500 may include an autonomous pentesting agent 105, a computing device 125, and a server 120, which may be examples of corresponding devices or systems as described with reference to FIGS. 1 and 4.

Alternative examples of the following may be implemented, where some operations are performed in a different order than described or are not performed at all. In some examples, operations may include additional features not mentioned below, or further operations may be added. Although the autonomous pentesting agent 105, the computing device 125, and the server 120 are shown performing the operations of the process flow 500, some aspects of some operations may also be performed by one or more other devices or systems.

At 505, the autonomous pentesting agent 105 may execute an autonomous pentest. For example, the autonomous pentesting agent 105 may gain unauthorized access to and use the computing device 125 to perform the operations of the process flow 500. In some examples, the autonomous pentesting agent 105 may deploy a RAT at the computing device 125 to perform the operations described herein, or the autonomous pentesting agent 105 may gain access to the computing device 125 directly. Put another way, the autonomous pentesting agent 105 may execute an autonomous pentest of a network, where executing the autonomous pentest includes gaining unauthorized access to a host device (e.g., the computing device 125) of a multiple host devices of the network.

At 510, the autonomous pentesting agent 105 may obtain a first cookie. For example, the autonomous pentesting agent 105 may obtain the first cookie by identifying and scanning a memory space of a target application on the computing device 125. That is, the autonomous pentesting agent 105 may obtain, using the unauthorized access to the computing device 125, a first cookie specific to a user of the network, the first cookie stored at a memory space of a target application on the computing device 125.

At 515 through 530, the autonomous pentesting agent 105 may communicate with the server 120 using the first cookie. For example, the autonomous pentesting agent 105 may communicate with the server 120 of the target application outside of the network, where communicating with the server 120 includes receiving a second cookie associated with the target application based on providing the first cookie to the server 120, the second cookie being specific to a digital environment of the target application and associated with the network.

At 515, the autonomous pentesting agent 105 may transmit a first request including the first cookie to the server 120. For example, the autonomous pentesting agent 105, via the computing device 125, may transmit a “GET” request to the server 120 including the first cookie. In response, at 520, the server 120 may transmit a response including an indication of a digital environment of the target application associated with the first cookie. That is, the server 120 may transmit a response including some data about a proper digital environment (e.g., workspace) that the first cookie may be used in.

At 525, the autonomous pentesting agent 105 may transmit a second request including the first cookie to the server 120. For example, the autonomous pentesting agent 105, via the server 120, may transmit a “who am I” request to the specific digital environment that is associated with the network. That is, the autonomous pentesting agent 105 may direct the second request to a particular tenant or portion of the server 120 that is associated with the network of the computing device 125. In response, at 530, the server 120 may transmit a response including data that, if scanned by the autonomous pentesting agent 105, may include a second cookie (e.g., a workspace-specific cookie). For example, the autonomous pentesting agent 105 may scan the second response to obtain the second cookie.

At 535, the autonomous pentesting agent 105 may transmit a request including the first cookie and the second cookie. For example, the autonomous pentesting agent 105 may request information from the digital environment of the application using the first cookie and the second cookie, which may allow the autonomous pentesting agent 105 to act as if they are the user associated with the first cookie and transmit authenticated API requests. At 540, in response to the request, the server 120 may provide the requested information. That is, the server 120 may provide the requested information based on the request including the first cookie and the second cookie.

The autonomous pentesting agent 105 may perform the operations described herein to gain unauthorized access to multiple applications. For example, the autonomous pentesting agent 105 may, during the autonomous pentest, gain unauthorized access to a first target application, then a second target application, and so on using the operations above. In other words, the operations of the process flow 500 may be repeated one or more times by the autonomous pentesting agent 105 during an autonomous pentest to attempt to gain unauthorized access to multiple target applications.

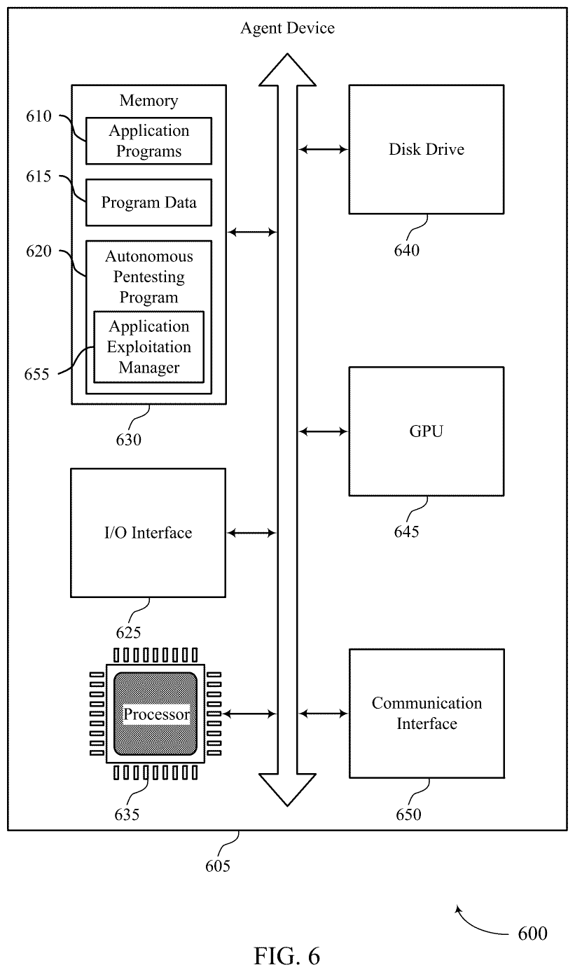

FIG. 6 shows a diagram of a system 600 including an agent device 605 that supports network application exploitation during autonomous pentesting in accordance with aspects of the present disclosure. The agent device 605 may be an example of a device or server on which an autonomous pentesting agent 105 is deployed as described herein. The agent device 605 may include components for network application exploitation during autonomous pentesting, such as a memory 630 including application programs 610, program data 615, an autonomous pentesting program 620, and an application exploitation manager 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting network application exploitation during autonomous pentesting. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting network application exploitation during autonomous pentesting). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network accessed by the agent device 605, such as accessed via the communication interface 650. That is, the autonomous pentesting program 620 may be configured to perform an autonomous pentest as described herein, including an autonomous pentest involving target application exploitation during autonomous pentesting.

The application exploitation manager 655 may support target application exploitation during autonomous pentesting in accordance with examples as disclosed herein. For example, the application exploitation manager 655 may be configured as or otherwise support a means for executing an autonomous pentest of a network, wherein executing the autonomous pentest comprises gaining unauthorized access to a host device of a plurality of host devices of the network. The application exploitation manager 655 may be configured as or otherwise support a means for obtaining, using the unauthorized access to the host device, a first cookie specific to a user of the network, the first cookie stored at a memory space of a target application on the host device. The application exploitation manager 655 may be configured as or otherwise support a means for communicating with a server of the target application outside of the network, wherein communicating with the server includes receiving a second cookie associated with the target application based on providing the first cookie to the server, the second cookie being specific to a digital environment of the target application and associated with the network. The application exploitation manager 655 may be configured as or otherwise support a means for obtaining, based at least in part on the unauthorized access to the host device and using the first cookie and the second cookie, information stored in the digital environment of the target application.

By including or configuring the application exploitation manager 655 in accordance with examples as described herein, the agent device 605 may support techniques for improved network security.

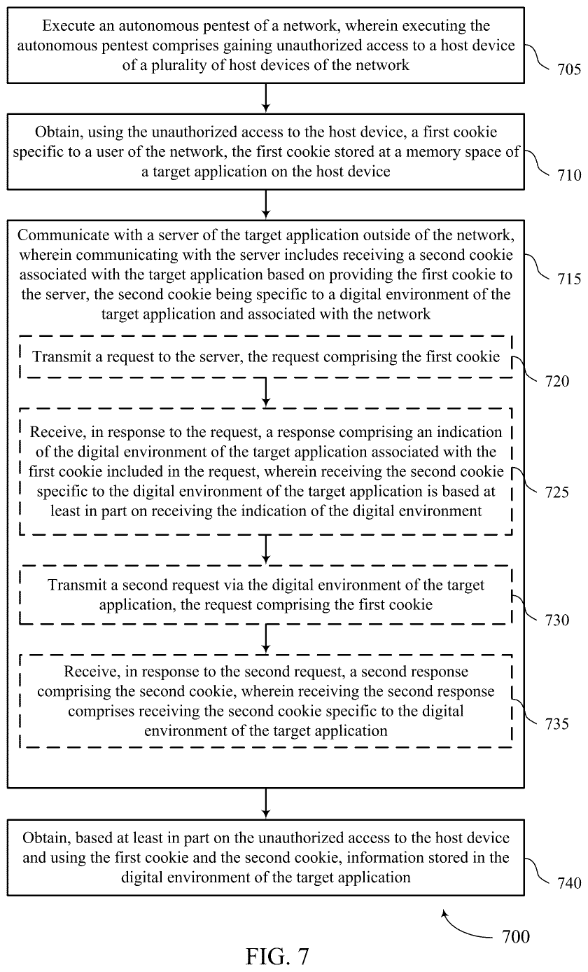

FIG. 7 shows a flowchart illustrating a method 700 that supports network application exploitation during autonomous pentesting in accordance with aspects of the present disclosure. The operations of the method 700 may be implemented by an agent device 605 or its components as described herein. In some examples, an agent device may execute a set of instructions to control the functional elements of the agent device to perform the described functions. Additionally, or alternatively, the agent device may perform aspects of the described functions using special-purpose hardware.

At 705, the method may include executing an autonomous pentest of a network, wherein executing the autonomous pentest comprises gaining unauthorized access to a host device of a plurality of host devices of the network. The operations of 705 may be performed in accordance with examples as disclosed herein.

At 710, the method may include obtaining, using the unauthorized access to the host device, a first cookie specific to a user of the network, the first cookie stored at a memory space of a target application on the host device. The operations of 710 may be performed in accordance with examples as disclosed herein.

At 715, the method may include communicating with a server of the target application outside of the network, wherein communicating with the server includes receiving a second cookie associated with the target application based on providing the first cookie to the server, the second cookie being specific to a digital environment of the target application and associated with the network. The operations of 715 may be performed in accordance with examples as disclosed herein.

At 720, the method may include transmitting a request to the server, the request comprising the first cookie. The operations of 720 may be performed in accordance with examples as disclosed herein.

At 725, the method may include receiving, in response to the request, a response comprising an indication of the digital environment of the target application associated with the first cookie included in the request, wherein receiving the second cookie specific to the digital environment of the target application is based at least in part on receiving the indication of the digital environment. The operations of 725 may be performed in accordance with examples as disclosed herein.

At 730, the method may include transmitting a second request via the digital environment of the target application, the request comprising the first cookie. The operations of 730 may be performed in accordance with examples as disclosed herein.

At 735, the method may include receiving, in response to the second request, a second response comprising the second cookie, wherein receiving the second response comprises receiving the second cookie specific to the digital environment of the target application. The operations of 735 may be performed in accordance with examples as disclosed herein.

At 740, the method may include obtaining, based at least in part on the unauthorized access to the host device and using the first cookie and the second cookie, information stored in the digital environment of the target application. The operations of 740 may be performed in accordance with examples as disclosed herein.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The following provides an overview of aspects of the present disclosure:
Aspect 1: A method for target application exploitation during autonomous pentesting, comprising: executing an autonomous pentest of a network, wherein executing the autonomous pentest comprises gaining unauthorized access to a host device of a plurality of host devices of the network; obtaining, using the unauthorized access to the host device, a first cookie specific to a user of the network, the first cookie stored at a memory space of a target application on the host device; communicating with a server of the target application outside of the network, wherein communicating with the server includes receiving a second cookie associated with the target application based on providing the first cookie to the server, the second cookie being specific to a digital environment of the target application and associated with the network; and obtaining, based at least in part on the unauthorized access to the host device and using the first cookie and the second cookie, information stored in the digital environment of the target application.
Aspect 2: The method of aspect 1, wherein communicating with the server further comprises: transmitting a request to the server, the request comprising the first cookie; and receiving, in response to the request, a response comprising an indication of the digital environment of the target application associated with the first cookie included in the request, wherein receiving the second cookie specific to the digital environment of the target application is based at least in part on receiving the indication of the digital environment.
Aspect 3: The method of aspect 2, further comprising: transmitting a second request via the digital environment of the target application, the request comprising the first cookie; and receiving, in response to the second request, a second response comprising the second cookie, wherein receiving the second response comprises receiving the second cookie specific to the digital environment of the target application.
Aspect 4: The method of any of aspects 1 through 3, wherein obtaining the information comprises: obtaining the information stored in the digital environment of the target application is based at least in part on using the second cookie to perform one or more functions within the digital environment of the target application, transmit authenticated API requests, or both.
Aspect 5: The method of any of aspects 1 through 4, wherein obtaining the information comprises: applying a file pilfering function associated with the autonomous pentest to extract sensitive information from the digital environment of the target application.
Aspect 6: The method of any of aspects 1 through 5, wherein obtaining the first cookie using the unauthorized access comprises: scanning the memory space of the target application to identify the first cookie, wherein the first cookie is stored in the memory space of the target application.
Aspect 7: The method of aspect 6, wherein obtaining the first cookie using the unauthorized access comprises: communicating, via one or more APIs, with one or more processes having process identifiers associated with the target application, wherein communicating with the one or more processes comprises querying the one or more APIs for information associated with the one or more processes, and wherein: the information comprises RAM usage, open file handles, and memory space addresses, and scanning the memory space is based at least in part on obtaining the memory space addresses after querying the one or more APIs.
Aspect 8: The method of any of aspects 6 through 7, wherein scanning the memory space comprises: scanning the memory space using a language model that extracts data from the memory space identified as being cookies, the language model trained using expressions or textual patterns of cookies.
Aspect 9: The method of any of aspects 6 through 8, wherein identifying the first cookie comprises: identifying the first cookie based at least in part on a proximity of the first cookie to a URL associated with an authentication endpoint of the target application in the memory space.
Aspect 10: The method of any of aspects 1 through 9, wherein obtaining the first cookie using the unauthorized access comprises: querying the memory space associated with the target application; and reading, after querying the memory space, content of the memory space, the content including the first cookie.
Aspect 11: The method of any of aspects 1 through 10, further comprising: detecting the target application on the host device after gaining the unauthorized access to the host device.
Aspect 12: The method of any of aspects 1 through 11, further comprising: detecting the target application on the host device based at least in part on identifying one or more processes running on the host device having names associated with the target application.
Aspect 13: The method of any of aspects 1 through 12, further comprising: detecting the target application on the host device based at least in part on accessing an operating system manifest comprising a plurality of applications including the target application installed on the host device, user-specific metadata associated with the target application, or both.
Aspect 14: The method of any of aspects 1 through 13, further comprising: outputting a network assessment report indicating the information stored in the digital environment of the target application.
Aspect 15: The method of aspect 14, wherein the network assessment report comprises one or more security policy recommendations that are in accordance with preventing the unauthorized access to the host device, preventing persistent storage of the information in the digital environment, or both.
Aspect 16: An apparatus for target application exploitation during autonomous pentesting, comprising one or more memories storing processor-executable code, and one or more processors coupled with the one or more memories and individually or collectively operable to execute the code to cause the apparatus to perform a method of any of aspects 1 through 15.
Aspect 17: An apparatus for target application exploitation during autonomous pentesting, comprising at least one means for performing a method of any of aspects 1 through 15.
Aspect 18: A non-transitory computer-readable medium storing code for target application exploitation during autonomous pentesting, the code comprising instructions executable by one or more processors to perform a method of any of aspects 1 through 15.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for target application exploitation during autonomous pentesting, comprising:
executing an autonomous pentest of a network, wherein executing the autonomous pentest comprises gaining unauthorized access to a host device of a plurality of host devices of the network;
obtaining, using the unauthorized access to the host device, a first cookie specific to a user of the network, the first cookie stored at a memory space of a target application on the host device;
communicating with a server of the target application outside of the network, wherein communicating with the server includes receiving a second cookie associated with the target application based on providing the first cookie to the server, the second cookie being specific to a digital environment of the target application and associated with the network; and
obtaining, based at least in part on the unauthorized access to the host device and using the first cookie and the second cookie, information stored in the digital environment of the target application.

2. The method of claim 1, wherein communicating with the server further comprises:
transmitting a request to the server, the request comprising the first cookie; and
receiving, in response to the request, a response comprising an indication of the digital environment of the target application associated with the first cookie included in the request, wherein receiving the second cookie specific to the digital environment of the target application is based at least in part on receiving the indication of the digital environment.

3. The method of claim 2, further comprising:
transmitting a second request via the digital environment of the target application, the request comprising the first cookie; and
receiving, in response to the second request, a second response comprising the second cookie, wherein receiving the second response comprises receiving the second cookie specific to the digital environment of the target application.

4. The method of claim 1, obtaining the information comprises:
obtaining the information stored in the digital environment of the target application is based at least in part on using the second cookie to perform one or more functions within the digital environment of the target application, transmit authenticated application programming interface (API) requests, or both.

5. The method of claim 1, wherein obtaining the information comprises:
applying a file pilfering function associated with the autonomous pentest to extract sensitive information from the digital environment of the target application.

6. The method of claim 1, wherein obtaining the first cookie using the unauthorized access comprises:
scanning the memory space of the target application to identify the first cookie, wherein the first cookie is stored in the memory space of the target application.

7. The method of claim 6, wherein obtaining the first cookie using the unauthorized access comprises:
communicating, via one or more application programming interfaces (APIs), with one or more processes having process identifiers associated with the target application, wherein communicating with the one or more processes comprises querying the one or more APIs for information associated with the one or more processes, and wherein:
the information comprises random access memory (RAM) usage, open file handles, and memory space addresses, and
scanning the memory space is based at least in part on obtaining the memory space addresses after querying the one or more APIs.

8. The method of claim 6, wherein scanning the memory space comprises:
scanning the memory space using a language model that extracts data from the memory space identified as being cookies, the language model trained using expressions or textual patterns of cookies.

9. The method of claim 6, wherein identifying the first cookie comprises:
identifying the first cookie based at least in part on a proximity of the first cookie to a uniform resource locator (URL) associated with an authentication endpoint of the target application in the memory space.

10. The method of claim 1, wherein obtaining the first cookie using the unauthorized access comprises:
querying the memory space associated with the target application; and
reading, after querying the memory space, content of the memory space, the content including the first cookie.

11. The method of claim 1, further comprising:
detecting the target application on the host device after gaining the unauthorized access to the host device.

12. The method of claim 1, further comprising:
detecting the target application on the host device based at least in part on identifying one or more processes running on the host device having names associated with the target application.

13. The method of claim 1, further comprising:
detecting the target application on the host device based at least in part on accessing an operating system manifest comprising a plurality of applications including the target application installed on the host device, user-specific metadata associated with the target application, or both.

14. The method of claim 1, further comprising:
outputting a network assessment report indicating the information stored in the digital environment of the target application.

15. The method of claim 14, wherein the network assessment report comprises one or more security policy recommendations that are in accordance with preventing the unauthorized access to the host device, preventing persistent storage of the information in the digital environment, or both.

16. An apparatus for target application exploitation during autonomous pentesting, comprising:
one or more memories storing processor-executable code; and
one or more processors coupled with the one or more memories and individually or collectively operable to execute the code to cause the apparatus to:
execute an autonomous pentest of a network, wherein executing the autonomous pentest comprises gaining unauthorized access to a host device of a plurality of host devices of the network;
obtain, using the unauthorized access to the host device, a first cookie specific to a user of the network, the first cookie stored at a memory space of a target application on the host device;
communicate with a server of the target application outside of the network, wherein communicating with the server includes receiving a second cookie associated with the target application based on providing the first cookie to the server, the second cookie being specific to a digital environment of the target application and associated with the network; and
obtain, based at least in part on the unauthorized access to the host device and using the first cookie and the second cookie, information stored in the digital environment of the target application.

17. The apparatus of claim 16, wherein, to communicate with the server, the one or more processors are individually or collectively further operable to execute the code to cause the apparatus to:
transmit a request to the server, the request comprising the first cookie; and
receive, in response to the request, a response comprising an indication of the digital environment of the target application associated with the first cookie included in the request, wherein receiving the second cookie specific to the digital environment of the target application is based at least in part on receiving the indication of the digital environment.

18. The apparatus of claim 17, wherein the one or more processors are individually or collectively further operable to execute the code to cause the apparatus to:
transmit a second request via the digital environment of the target application, the request comprising the first cookie; and
receive, in response to the second request, a second response comprising the second cookie, wherein receiving the second response comprises receiving the second cookie specific to the digital environment of the target application.

19. A non-transitory computer-readable medium storing code for target application exploitation during autonomous pentesting, the code comprising instructions executable by one or more processors to:
execute an autonomous pentest of a network, wherein executing the autonomous pentest comprises gaining unauthorized access to a host device of a plurality of host devices of the network;
obtain, using the unauthorized access to the host device, a first cookie specific to a user of the network, the first cookie stored at a memory space of a target application on the host device;
communicate with a server of the target application outside of the network, wherein communicating with the server includes receiving a second cookie associated with the target application based on providing the first cookie to the server, the second cookie being specific to a digital environment of the target application and associated with the network; and
obtain, based at least in part on the unauthorized access to the host device and using the first cookie and the second cookie, information stored in the digital environment of the target application.

20. The non-transitory computer-readable medium of claim 19, wherein the instructions to obtain the information are executable by the one or more processors to:
obtain the information stored in the digital environment of the target application is based at least in part on using the second cookie to perform one or more functions within the digital environment of the target application, transmit authenticated application programming interface (API) requests, or both.
